(19) United States
(12) Patent Application Publication
(10) Pub. No.: US 2025/0112772 A1
(43) Pub. Date: Apr. 3, 2025

(54) ON-DIE KEY GENERATOR FOR FULLY-HOMOMORPHIC ENCRYPTION RELINEARIZATION PUBLIC KEYS

(71) Applicant: Intel Corporation, Santa Clara, CA (US)

(72) Inventors: Sachin TANEJA, Hillsboro, OR (US); Sanu K. MATHEW, Portland, OR (US); Christopher B. WILKERSON, Vancouver, WA (US); Raghavan KUMAR, Hillsboro, OR (US); Anupam GOLDER, Hillsboro, OR (US)

(21) Appl. No.: 18/375,421

(22) Filed: Sep. 29, 2023

(51) Int. Cl. H04L 9/30; H04L 9/00; H04L 9/08

(52) U.S. Cl. CPC H04L 9/3093; H04L 9/008; H04L 9/0869

(57) ABSTRACT

Bandwidth of High Bandwidth Memory (HBM) and scratch pad memory used by an Fully Homomorphic Encryption (FHE) accelerator in a System-on-Chip (SoC) during FHE relinearization is reduced by including a key generator module in the SoC. The key generator module to generate FHE public keys from a seed that is input to the SoC. The seed used by the on-die key generator module to generate FHE relinearization public keys locally within the scratch pad memory units in the SoC.

### STATEMENT REGARDING FEDERALLY SPONSORED RESEARCH

This invention was made with Government support under contract number HR0011-21-3-0003-0104 awarded by the Department of Defense. The Government has certain rights in this invention.

### BACKGROUND

Fully Homomorphic Encryption (FHE) is a form of encryption that allows computations to be performed on encrypted data without first having to decrypt it. The computations are performed on polynomials. The degree of a polynomial is the highest of the degrees of the polynomial's individual terms with non-zero coefficients. The degree of a term is the sum of the exponents of the variables in the term. The degree of the polynomial is the highest exponent in the polynomial.

For example, the polynomial 5x²y⁴+3x−10 has three terms, two variables (x, y) and two coefficients (number that is being multiplied by a variable). The first term has a degree of 6 (the sum of exponent 2 and exponent 4), the second term has a degree of 1 and the third term has a degree of 0. The polynomial has a degree of 6 (the highest exponent of the terms in the polynomial).

Fully Homomorphic Encryption (FHE) enables computation on encrypted data, or ciphertext, rather than plaintext, or unencrypted data, keeping data protected at all times. FHE uses lattice cryptography, which presents complex mathematical challenges to would-be attackers.

FHE standards support a wide range of polynomials, with the degree of the polynomial ranging from 1024 (1K) up to 128K and where each coefficient in the polynomial can range from 32 bits up to 2K bits dependent on the degree of the polynomial.

### BRIEF DESCRIPTION OF DRAWINGS

Various examples in accordance with the present disclosure will be described with reference to the drawings, in which:

FIG. 1 illustrates an example system;

FIG. 2 illustrates an example of system that includes a fully homomorphic encryption accelerator including key generator circuitry to generate fully homomorphic encryption accelerator (FHE) public keys;

FIG. 3 illustrates an example of key generator circuitry in the scratch pad memory units shown in FIG. 2;

FIG. 4 is block diagram of one key generator circuitry in the KeyGen module that includes 16 key generator circuitry in the FHE accelerator;

FIG. 5 is a block diagram of SPM units in the FHE accelerator;

FIG. 6 is a flowgraph of a method performed in the FHE accelerator to generate fully-homomorphic encryption relinearization public keys;

FIG. 7A illustrates examples of an instruction format;

FIG. 7B illustrates a Key Generation seed (KG_seed) instruction to load a seed stored in scratch pad memory from the scratch pad memory to key generation registers;

FIG. 7C illustrates a Key Generation start stop (KG_start_stop) instruction to toggle the state of the Key Generation operation between start and stop and stop and start;

FIG. 7D illustrates a Key Generation load (KG_load) instruction to load the key generated by the key generation instruction from the buffer into the compute engine;

FIG. 8 illustrates an example computing system;

FIG. 9 illustrates a block diagram of an example SoC that may have one or more processor cores and an integrated memory controller;

FIG. 10(A) is a block diagram illustrating both an example in-order pipeline and an example register renaming, out-of-order issue/execution pipeline according to examples;

FIG. 10(B) is a block diagram illustrating both an example in-order architecture core and an example register renaming, out-of-order issue/execution architecture core to be included in a processor according to examples;

FIG. 11 illustrates examples of execution unit(s) circuitry;

FIG. 12 is a block diagram of a register architecture according to some examples;

FIG. 13 illustrates examples of an addressing information field;

FIG. 14 illustrates examples of a first prefix;

FIGS. 15(A)-(D) illustrate examples of how the R, X, and B fields of the first prefix in FIG. 14 are used;

FIGS. 16(A)-(B) illustrate examples of a second prefix;

FIG. 17 illustrates examples of a third prefix; and

FIG. 18 is a block diagram illustrating the use of a software instruction converter to convert binary instructions in a source instruction set architecture to binary instructions in a target instruction set architecture according to examples.

### DETAILED DESCRIPTION

Fully-Homomorphic-Encryption (FHE) ciphertext is represented as a pair of polynomials C₀ and C₁ (2-term ciphertext [C₀, C₁]). FHE multiplication on a 2-term ciphertext ([C₀,C₁] and a 2-term ciphertext [D₀,D₁]) results in a 3-term ciphertext ([E₀, E₁, E₂]). FHE Relinearization remaps the 3-term ciphertext ([E₀, E₁, E₂]) back to a 2-term ciphertext ([F₀, F₁]), which decrypts to the same value as the 3-term ciphertext ([E₀, E₁, E₂]). For a polynomial with degree of 16K, each polynomial is 1 Mega Bytes. Hence, back-to-back FHE multiplications result in FHE ciphertexts of increasing sizes.

One of the polynomials in the pair of polynomials C₀ and C₁ representing the Fully-Homomorphic-Encryption (FHE) ciphertext is a public key A. A key generator in software is used to generate the public key A from a seed. For example, a software Application Program Interface (API) can be used to generate the public key A using a key generator implemented in a library (for example, OpenFHE, SEAL (Software-Optimized Encryption Algorithm)). The public key A is loaded into a System-on-Chip (SoC) that includes a FHE accelerator to perform a FHE relincarization operation. The FHE accelerator includes High Bandwidth Memory (HBM), scratch pad memory and a compute engine. The public key A used to perform the FHE relincarization operation is stored in the HBM and the scratch pad memory in the FHE accelerator. The public key A uses a significant portion of the HBM and the scratch pad memory. For example, a relincarization key can consume between tens to hundreds of Mega Bytes (MB) s dependent on the polynomial size. The public key A consumes HBM bandwidth and scratch pad memory bandwidth. For example, about 90% of the data moved from the HBM to the scratch pad memory during FHE relinearization operations is related to key-switching-material.

HBM bandwidth and scratch pad memory bandwidth used during FHE relinearization is reduced by including an on-die key generator in the SoC to generate the FHE public keys from a seed that is input to the SoC. The seed is used by the on-die key generator module to generate FHE relinearization public keys locally within the scratch pad memory units in the SoC.

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

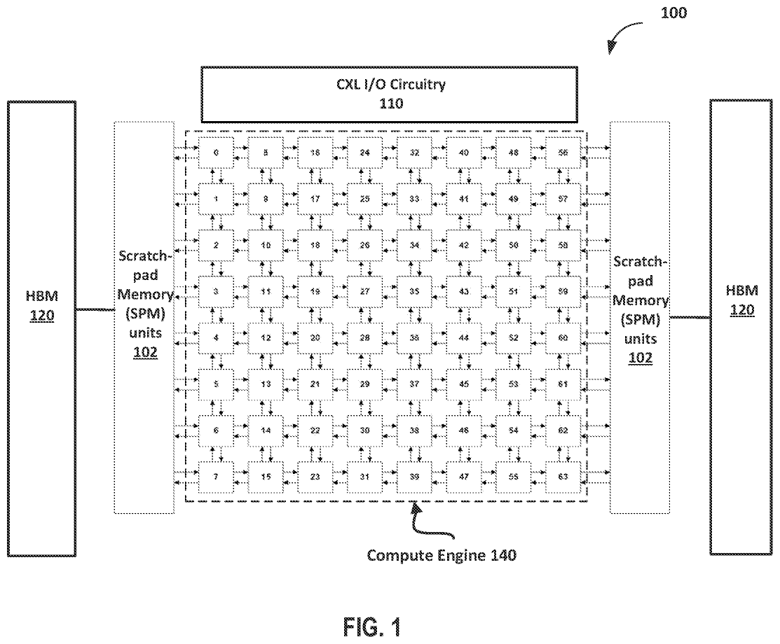

FIG. 1 illustrates an example system 100. In some examples, system 100 can be included in and/or operate within a compute platform. The compute platform, for example, could be located in a data center included in, for example, cloud computing infrastructure, examples are not limited to system 100 included in a compute platform located in a data center. As shown in FIG. 1, system 100 includes compute express link (CXL) input/output (I/O) circuitry 110, high bandwidth memory (HBM) 120, scratch pad memory units 102 and tile array in a compute engine 140 (also referred to as a tile array).

In some examples, system 100 can be configured as a parallel processing device or accelerator to perform FHE relinearization operations/computations for accelerating FHE workloads. For these examples, CXL I/O circuitry 110 can be configured to couple with one or more host central processing units (CPUs—not shown) to receive instructions and/or data via circuitry designed to operate in compliance with one or more CXL specifications published by the CXL Consortium to included, but not limited to, CXL Specification, Rev. 2.0, Ver. 1.0, published Oct. 26, 2020, or CXL Specification, Rev. 3.0, Ver. 1.0, published Aug. 1, 2022. Also, CXL I/O circuitry 110 can be configured to enable one or more host CPUs to obtain data associated with execution of accelerated FHE workloads by compute elements included in interconnected tiles of the compute engine 140. For example, data (for example, ciphertext or processed ciphertext) may be moved to or moved from HBM 120 and CXL I/O circuitry 110 can facilitate the data movement into or out of HBM 120 as part of execution of accelerated FHE workloads. Also, scratch pad memory in scratch pad memory units 102 can be a type of memory (for example, register files) that can be proportionately allocated to tiles included in tile array in compute engine 140 to facilitate execution of the accelerated FHE workloads and to perform FHE relinearization operations. Scratch pad memory is used to store coefficients used by the plurality of compute elements to perform operations on polynomials.

In some examples, as described in more detail below, tile array in compute engine 140 can be arranged in an 8×8 tile configuration as shown in FIG. 1 that includes tiles 0 to 63. For these examples, each tile can include, but is not limited to, 128 compute elements (not shown in FIG. 1). As shown in FIG. 1, tiles 0 to 63 can be interconnected via point-to-point connections via a 2-dimensional (2D) mesh interconnect-based architecture. The 2D mesh enables communications between adjacent tiles using single-hop links. Tiles included in tile array in compute engine 140 can be augmented with router circuitry that can route data received via inputs or sent via outputs across all 4 directions.

Examples are not limited to use of CXL I/O circuitry such as CXL I/O circuitry 110 to facilitate receiving instructions and/or data or providing executed results associated with FHE workloads. Other types of I/O circuitry and/or additional circuitry to receive instructions and/or data or provide executed results are contemplated.

Examples are not limited to HBM such as HBM 120 for receiving data to be processed (memory to store the data to be processed) or to store information associated with instructions to execute an FHE workload or execution results of the FHE workload. Other types of volatile memory or non-volatile memory are contemplated for use in system 100. Other types of volatile memory can include, but are not limited to, Dynamic RAM (DRAM), DDR synchronous dynamic RAM (DDR SDRAM), GDDR, static random-access memory (SRAM), thyristor RAM (T-RAM) or zero-capacitor RAM (Z-RAM). Non-volatile types of memory can include byte or block addressable types of non-volatile memory such as, but not limited to, multi-threshold level NAND flash memory, NOR flash memory, single or multi-level phase change memory (PCM), resistive memory, nanowire memory, ferroelectric transistor random access memory (FeTRAM), anti-ferroelectric memory, resistive memory including a metal oxide base, an oxygen vacancy base and a conductive bridge random access memory (CB-RAM), a spintronic magnetic junction memory, a magnetic tunneling junction (MTJ) memory, a domain wall (DW) and spin orbit transfer (SOT) memory, a thyristor based memory, a magnetoresistive random access memory (MRAM) that incorporates memristor technology, spin transfer torque MRAM (STT-MRAM), or a combination of any of the above.

According to some examples, system 100 can be included in a system-on-a-chip (SoC). SoC is a term often used to describe a device or system having a compute elements and associated circuitry (e.g., I/O circuitry, butterfly circuits, power delivery circuitry, memory controller circuitry, memory circuitry, etc.) integrated monolithically into a single integrated circuit (“IC”) die, or chip. For example, a device, computing platform or computing system could have one or more compute elements (for example, butterfly circuits) and associated circuitry (for example, I/O circuitry, power delivery circuitry, memory controller circuitry, memory circuitry, etc.) arranged in a disaggregated collection of discrete dies, tiles and/or chiplets (e.g., one or more discrete compute die arranged adjacent to one or more other die such as memory die, I/O die, etc.). The compute elements to support operations on polynomials. In such disaggregated devices and systems the various dies, tiles and/or chiplets could be physically and electrically coupled together by a package structure including, for example, various packaging substrates, interposers, interconnect bridges and the like. Also, these disaggregated devices can be referred to as a system-on-a-package (SoP).

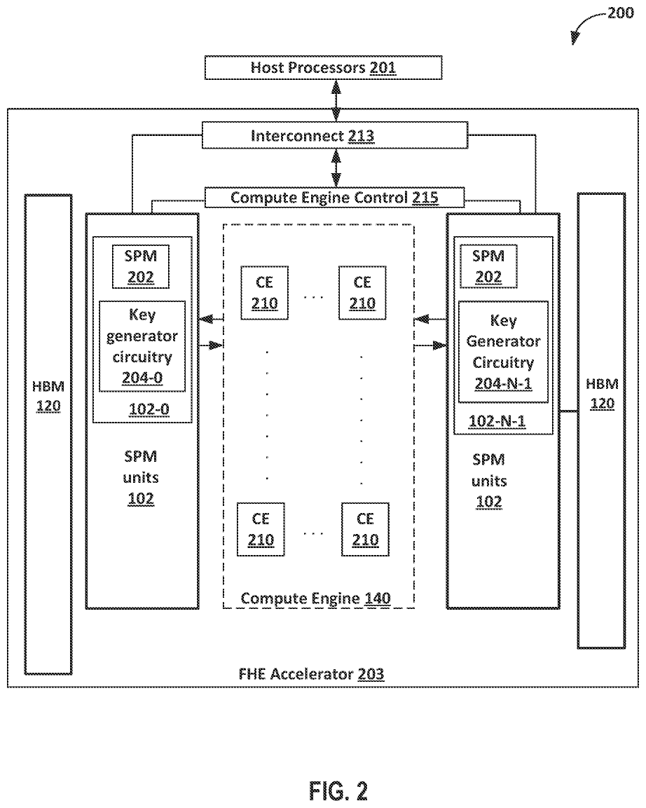

FIG. 2 illustrates an example of system 200 that includes a fully homomorphic encryption accelerator 203 including key generator circuitry 204 to generate Fully Homomorphic Encryption (FHE) public keys. As shown, the FHE accelerator 203 couples to one or more host processors 201 such as one or more central processing unit (CPU) cores via one or more interconnects 213.

The one or more interconnects 213 are coupled to scratch pad memory (SPM) units 102 which handle load/stores of data and provide data for execution by the compute engine 140 comprising a tile array that includes tiles 0 to 63 as shown in FIG. 1. In some examples, tiles 0 to 63 are coupled to scratch pad memory units 102, the interconnect 213, and/or a compute engine control block 215. Tiles in the compute engine 140 include compute elements 210. In an embodiment, each tile can include, but is not limited to, 128 compute elements 210. Scratch pad memory in scratch pad memory units 102 can be a type of memory (for example, register files).

The scratch pad memory units 102 are coupled to high bandwidth memory (HBM) 120 which stores a larger amount of data. In some examples, the data is distributed across HBM 120 and banks of scratch pad memory in scratch pad memory units 102. In some examples, HBM 120 is external to the FHE accelerator 203. In some examples, some HBM 120 is external to the FHE accelerator 403 and some HBM 120 is internal to the FHE accelerator 203.

The scratch pad memory units 102 include N scratch pad memory units 120-0 . . . 120-N−1. In an embodiment N is 16. In other embodiments, N can be 4-32. Each scratch pad memory unit 102-0 includes key generator circuitry 204 and scratch pad memory 202.

In some examples, a compute engine control block 215 dispatches instructions and handles synchronization of data from the HBM 120 and scratch pad memory units 102 for the compute engine 140. In some examples, memory loads and stores are tracked in the compute engine control block 215 and dispatched across the scratch pad memory units 102 for coordinated data fetch. These loads and stores are handled locally in the scratch pad memory units 102 and written into the scratch pad memory in scratch pad memory units 102 and/or HBM 120. In some examples, the compute engine control block 215 includes an instruction decoder to decode the instructions detailed herein. In some examples, a decoder of a host processor 401 decodes the instructions to be executed by the FHE compute engine 140.

In some examples, the basic organization of the FHE compute engine 140 is a wide and flexible array of functional units organized in a butterfly configuration. The array of butterfly units is tightly coupled with a register file in scratch pad memory 202 in a scratch pad memory unit 102-0 capable of storing one or more of FHE operands (e.g., entire input and output ciphertexts), twiddle factor constants, relevant public key material, etc. In some examples, the FHE operands, twiddle factors, key information, etc. are stored as polynomial coefficients.

The FHE compute engine 140 performs polynomial multiplication, addition, modulo reduction, etc. Given aᵢ and bᵢ in [symbol] _{q}, two polynomials a(x) and b(x) over the ring can be expressed as

$$a ( x ) = {a}_{0} + {a}_{1} x + {a}_{2} {x}^{2} + … {a}_{n - 1} {x}^{n - 1}$$

$$b ( x ) = {b}_{0} + {b}_{1} x + {b}_{2} {x}^{2} + … {b}_{n - 1} {x}^{n - 1}$$

Each of the scratch pad memory units 102 includes key generator circuitry 204 that is used during FHE relinearization to generate FHE relinearization public keys from a seed that is input to the Key generator circuitry 204 in a key generation seed (KG_seed) instruction sent by the host processors 201. The seed is used by the key generator circuitry 204 to generate FHE relinearization public keys locally within the scratch pad memory units 102 in the FHE accelerator 203. Scratch pad memory to store coefficients used by the plurality of compute elements to perform operations on polynomials.

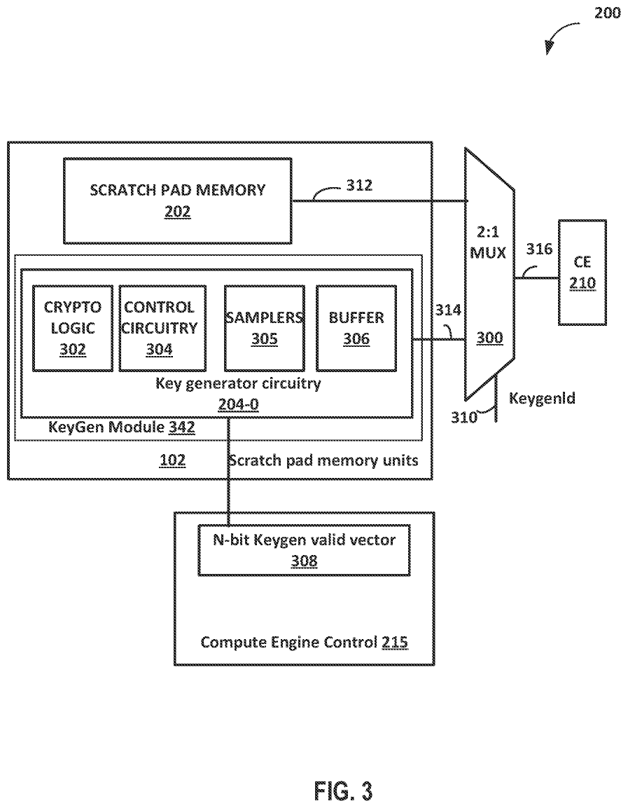

FIG. 3 illustrates an example of key generator circuitry 204 in the scratch pad memory units 102 shown in FIG. 2. A KeyGen module 342 includes key generator circuitry 204 that is distributed across the scratch pad memory units 102.

Each key generator circuitry 204-0 . . . 204-N−1 includes crypto logic 302, samplers 305, a buffer 306, and control circuitry 304 to manage key material generation. The crypto logic 302 generates raw random number generator values. The samplers 305 to map the raw random values received from the crypto logic 302 from a number space to a ciphertext modulus space. The buffer 306 stores valid values received from the samplers 305.

The key generator circuitry output 314 from the key generator circuitry 204 and the scratch pad memory output 312 from the scratch pad memory 202 are input to a 2:1 multiplexor 300. In the normal mode of operation, the state of the KG_load signal 310 is set so that the scratch pad memory output 312 from the scratch pad memory 202 is output from the 2:1 multiplexor 300 to the compute element (CE) 210. 512 Bytes of data is written every cycle to the CE 210 on a CE bus 316.

After a KG_load instruction is executed, the state of the KG_load signal 310 is switched to allow the key generator circuitry 204 to write a 512 Byte key data output 314 from key generator circuitry 204 to the compute element 210 by setting the state of the KG_load signal 310 so that the 512 Byte key data output 314 from key generator circuitry 204 is output from the 2:1 multiplexor 300 to the compute element (CE) 210.

The compute engine control block 215 includes an N-bit Keygen valid vector 308 to track completion status of the keygen material in the N scratch pad memory units 102. The N-bit Keygen valid vector 308 includes one bit for each key generator circuitry 204. A respective bit in the N-bit Keygen valid vector 308 is asserted (for example, set to logic ‘1’) when the buffer 306 in the key generator circuitry 204 is full. A KG_load instruction reads the N-bit keygen valid vector 308, if all N bits are not valid, the KG_load instruction stalls until all N bits are valid. After all N bits are valid, the KG_load instruction reads the key material in the buffer 306 in each of the key generator circuitry 204 and clears (for example, sets bits to ‘0’) the N bits in the N-bit keygen valid vector 308. In an embodiment N is 16.

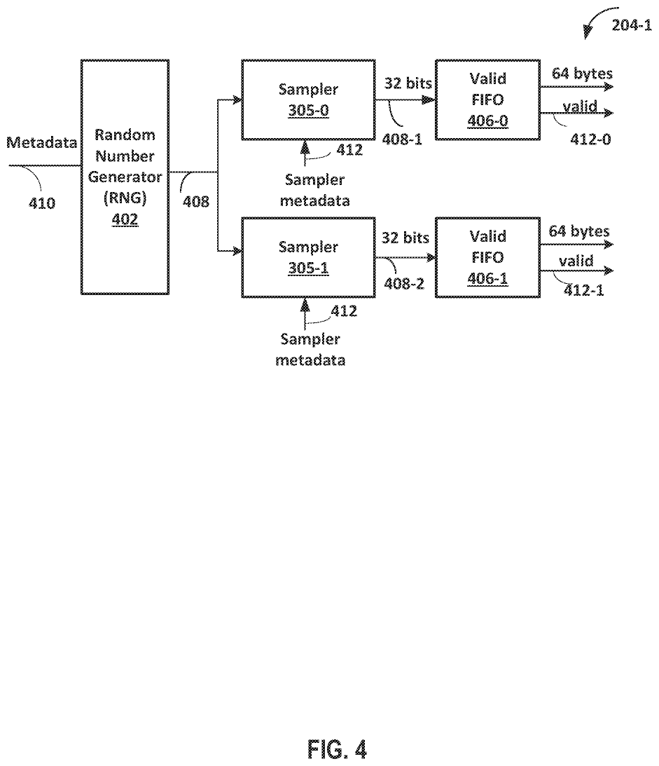

FIG. 4 is block diagram of one key generator circuitry 204-0 in the KeyGen module 342 that includes 16 key generator circuitry 204 in the FHE accelerator 203. Key generator circuitry 204-0 includes a random number generator (RNG) 402 that uses received metadata 410 to generate 64 random bits. The metadata 410 includes a random nonce, random data and a random key numbers that are used to generate the 64 random bits.

In an embodiment, the KeyGen module 342 uses key generator circuitry 204 of the PRESENT 80/64 cipher-based random number generator (RNG) 402 cascaded with sampler 305-0 and sampler 305-1. PRESENT is an Ultra-Lightweight Block Cipher with a 64-bit block size. In an embodiment, the key size is 80-bits. In other embodiment, the key size can be 128-bits. In other embodiments, other ciphers, for example, alternate symmetric key ciphers such as AES, ASCON, SIMON can be used.

Each key generator circuitry 204 generates 64 bits per cycle random output at 2 Giga Hz (GHz) resulting in an overall KeyGen module throughput of 2 Tera bits per second (Tbps). The pair of samplers 305-0, 305-1 uniformly map raw RNG values from the number space of 0-2³² to the ciphertext modulus space of 0-q. The raw RNG values are generated by the cipher-based random number generator (RNG) 402.

Each of the samplers 305-0, 305-1 receives 32 bits of the 64 bits of raw random number generator values 408 generated by the cipher-based random number generator (RNG) 402. The samplers 305-0, 305-1 to receive sampler metadata 412. The samplers 305-0, 305-1 to map numbers in number space [0, 2³²] to ciphertext modulus space [0, modulus] with lowest rejection for high throughput (that is, efficiency) and forward valid values to Valid FIFO 406-0 and Valid FIFO 406-1. A value is valid if it is in the ciphertext modulus space of 0-q. For example, if q is 7 and the number space is 0-2+ (values between 0 and 15), values 0-6 are valid and values 7-15 are not valid.

Valid FIFO 406-0 and Valid FIFO 406-1 are buffers to store valid values received from samplers 305-0, 305-1 until 64 bytes of valid values are stored in Valid FIFO 406-0 and 64 bytes of valid values are stored in Valid FIFO 406-0. The state of valid signal 412-0 output from Valid FIFO 406-0 is set to “valid” when Valid FIFO 406-0 stores 64 valid bits. The state of valid signal 412-1 output from Valid FIFO 406-1 is set to “valid” when Valid FIFO 406-0 stores 64 valid bits.

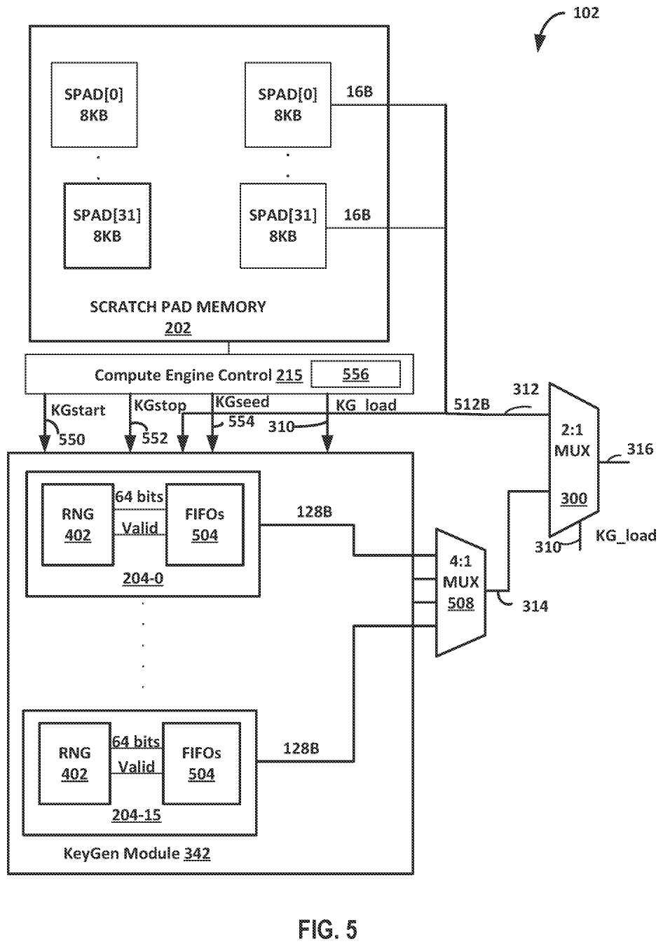

FIG. 5 is a block diagram of SPM units 102 in the FHE accelerator 203. SPM units 102 include scratch pad memory 202 and KeyGen module 342. The KeyGen module 342 includes 16 key generator circuitry 204-0 . . . 204-15. Each key generator circuitry 204-0 . . . 204-15 includes a random number generator (RNG) 402 and FIFOs 504 to store valid bits.

Decode circuitry 556 in the compute engine control block 215 decodes KeyGen instructions to generate a KG_start signal 550, a KG_stop signal 552, a KG_seed signal 554 and a KG_load signal 310 to control the finite-state-machine in the KeyGen module 342.

Each key generator circuitry 204-0 . . . 204-15 is loaded with a 208 bit seed value in response to a KG_seed instruction. The 208 bit seed value is sent to the KeyGen module 342 from the scratch pad memory 202 on the scratch pad memory output 312.

The KG_start signal 550 is generated to start key generation operations in response to a KG_start_stop instruction when the decode circuitry 556 in the compute engine control block 215 decodes the KG_start_stop instruction. The KG_start signal 550 initiates parallel key generation operations in each key generator circuitry 204-0 . . . , 204-15. Local valid signals are used to gate the RNG 402 when the 128 bytes FIFO 504-0 . . . 504-15 for the respective key generator circuitry 204-0 . . . 204-15 has been filled with 128 bytes of valid key material.

The KG_stop signal 552 is generated in response to a KG_start_stop instruction when the decode circuitry in the compute engine control block 215 decodes a KG_start_stop instruction. If the keygen state machine is in an active state (generating key material), the KG_stop signal 552 stops the key generation operations in each key generator circuitry 204-0 . . . , 204-15.

The KG_load signal 310 generated in response to a KG_start_stop instruction when the decode circuitry in the compute engine control block 215 decodes a KG_load instruction reads the 2 Kilo Bytes (KB) key material stored in the FIFOs 504-0, . . . 504-15 over 4 cycles, with 512 bytes of key material read per cycle from FIFOs in four of the key generator circuitry 204-0 . . . , 204-15. An output 4:1 multiplexor 508 routes the outputs of 4 of 16 FIFOs 504-0, . . . 504-15 to the KeyGen output 314 in each cycle.

The KeyGen output 314 from 4:1 multiplexor 508 is multiplexed (2:1 multiplexor 300) with the scratchpad output 312 to drive the CE bus 316. After the 2 KB key material has been read from the FIFOs 504-0, . . . 504-15 valid signals are reset.

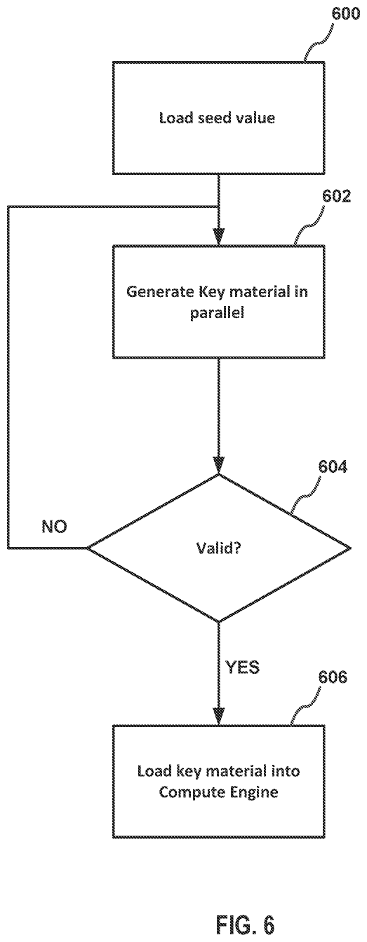

FIG. 6 is a flowgraph of a method performed in the FHE accelerator 203 to generate fully homomorphic encryption relinearization public keys.

At block 600, a KG_seed instruction loads the seed (a 208 bit seed value) in each key generator circuitry 204-0 . . . , 204-15 in the KeyGen module 342. Processing continues with block 602.

At block 602, the KG_start signal 550 generated when the scratch pad memory decodes a KG_start_stop instruction initiates parallel key generation operations in each key generator circuitry 204-0 . . . , 204-15. Processing continues with block 604.

At block 604, a KG_load instruction reads the keygen valid vector 308, if all bits in the keygen valid vector 308 are not valid, processing continues with block 602 to continue to perform key generation operations. If all bits in the keygen valid vector 308 are valid, processing continues with block 606.

At block 606, all bits in the keygen valid vector 308 are valid. The KG_load instruction reads the key material in the buffer 306 in each of the key generator circuitry 204 and clears (for example, sets bits to ‘0’) the N bits in the N-bit keygen valid vector 308. The state of the KG_load signal 310 is set so that the 512 bit key data output 314 from the key generator circuitry 204 is output from the 2:1 multiplexor 300 to the Compute Engine (CE) 210.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source 1/destination and source2); and an occurrence of this ADD instruction in an instruction stream will have specific contents in the operand fields that select specific operands.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

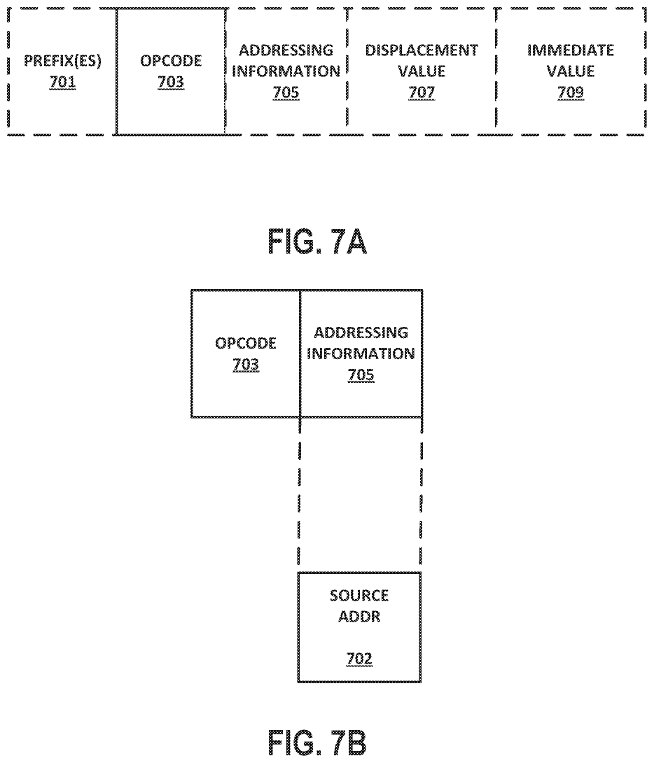

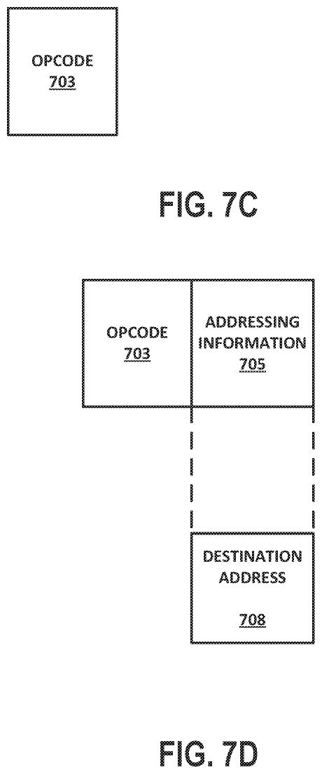

FIG. 7A illustrates examples of an instruction format. As illustrated, an instruction may include multiple components including, but not limited to, one or more fields for: one or more prefixes 701, an opcode 703, addressing information 705 (e.g., register identifiers, memory addressing information, etc.), a displacement value 707, and/or an immediate value 709. Note that some instructions utilize some or all the fields of the format whereas others may only use the field for the opcode 703. In some examples, the order illustrated is the order in which these fields are to be encoded, however, it should be appreciated that in other examples these fields may be encoded in a different order, combined, etc.

The prefix(es) field(s) 701, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 703 is used to at least partially define the operation to be performed upon a decoding of the instruction. In some examples, a primary opcode encoded in the opcode field 703 is one, two, or three bytes in length. In other examples, a primary opcode can be a different length. An additional 3-bit opcode field is sometimes encoded in another field.

The addressing information field 705 is used to address one or more operands of the instruction, such as a location in memory or one or more registers.

FIG. 7B illustrates a Key Generation seed (KG_seed) instruction to load seed material stored in scratch pad memory 202 from the scratch pad memory 202 to key generator circuitry 204.

The instruction format is (opcode, src_address). The opcode field 703 is used to define the operation (load seed stored in the scratchpad into key generation logic) to be performed upon a decoding of the instruction. The addressing information field 705 is used to address the operands of the Key Generation seed instruction. The operand is a field (source address 702) to indicate a source location in the scratch pad memory 202. In other embodiments, the key generation seed instruction to load a seed (seed material) from scratch pad memory to key generation registers may have fewer or more operands than what is shown in FIG. 7B.

FIG. 7C illustrates a Key Generation start stop (KG_start_stop) instruction to toggle the state of the Key Generation operation between start and stop and stop and start.

The instruction format is (opcode). The opcode field 703 is used to define the operation (Key Generation start or stop) to be performed upon a decoding of the instruction. If the keygen state machine is in a stopped state, the KG_start_stop instruction starts the keygen state machine. If the keygen state machine is in an active state (generating key material), the KG_start_stop stops the keygen state machine. In another embodiment, a KG_start_stop instruction may not be used to stop, the key generation can stop automatically after the buffer is full.

In other embodiments, the key generation start stop instruction to toggle the state of the key generation operation may have fewer or more operands than what is shown in FIG. 7C.

FIG. 7D illustrates a Key Generation load (KG_load) instruction to load the key generated by the key generation instruction stored in a buffer in the scratch pad memory units 102-0 . . . 102-N−1 from the buffer into the compute engine.

The instruction format is (opcode, dst_address). The opcode field 703 is used to define the operation (load the key generated by the key generation instruction from the buffer into the compute engine). The addressing information field 705 is used to address the operands of the Key Generation load instruction. The operand is a destination address 708 to indicate a destination (for example, compute engine) for the key stored in the buffer. In other embodiments, the Key Generation load (KG_load) instruction to load the key generated by the key generation instruction from the buffer into the compute engine may have fewer or more operands than what is shown in FIG. 7D.

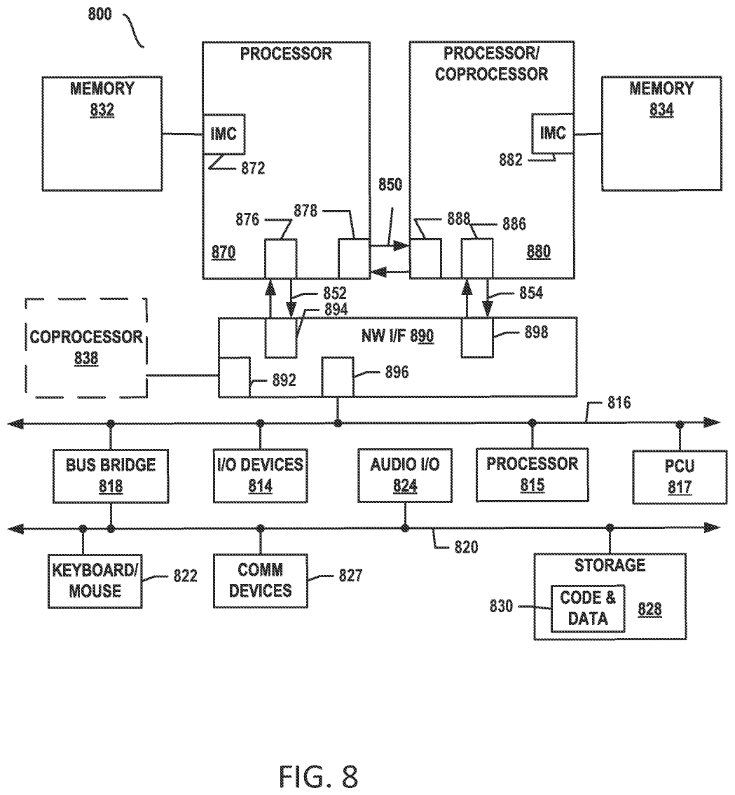

FIG. 8 illustrates an example computing system. Multiprocessor system 800 is an interfaced system and includes a plurality of processors or cores including a first processor 870 and a second processor 880 coupled via an interface 850 such as a point-to-point (P-P) interconnect, a fabric, and/or bus. In some examples, the first processor 870 and the second processor 880 are homogeneous. In some examples, first processor 870 and the second processor 880 are heterogenous. Though the example system 800 is shown to have two processors, the system may have three or more processors, or may be a single processor system. In some examples, the computing system is a system on a chip (SoC).

Processors 870 and 880 are shown including integrated memory controller (IMC) circuitry 872 and 882, respectively. Processor 870 also includes interface circuits 876 and 878; similarly, second processor 880 includes interface circuits 886 and 888. Processors 870, 880 may exchange information via the interface 850 using interface circuits 878, 888. IMCs 872 and 882 couple the processors 870, 880 to respective memories, namely a memory 832 and a memory 834, which may be portions of main memory (system memory) locally attached to the respective processors. The memory 832 and memory 834 to store instructions and data.

Processors 870, 880 may each exchange information with a network interface (NW I/F) 890 via individual interfaces 852, 854 using interface circuits 876, 894, 886, 898. The network interface 890 (e.g., one or more of an interconnect, bus, and/or fabric, and in some examples is a chipset) may optionally exchange information with a co-processor 838 via an interface circuit 892. In some examples, the co-processor 838 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 870, 880 or outside of both processors, yet connected with the processors via an interface such as a point to point (P-P) interconnect, such that either or both processors' local cache information may be stored in the shared cache if a processor is placed into a low power mode.

Network interface 890 may be coupled to a first interface 816 via interface circuit 896. In some examples, first interface 816 may be an interface such as a Peripheral Component Interconnect (PCI) interconnect, a PCI Express interconnect or another I/O interconnect. In some examples, first interface 816 is coupled to a power control unit (PCU) 817, which may include circuitry, software, and/or firmware to perform power management operations with regard to the processors 870, 880 and/or co-processor 838. PCU 817 provides control information to a voltage regulator (not shown) to cause the voltage regulator to generate the appropriate regulated voltage. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software.

Various I/O devices 814 may be coupled to first interface 816, along with a bus bridge 818 which couples first interface 816 to a second interface 820. In some examples, one or more additional processor(s) 815, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 816. In some examples, second interface 820 may be a low pin count (LPC) interface. Various devices may be coupled to second interface 820 including, for example, a keyboard and/or mouse 822, communication devices 827 and storage circuitry 828. Storage circuitry 828 may be one or more non-transitory machine-readable storage media as described below, such as a disk drive or other mass storage device which may include instructions/code and data 830 and may implement the storage 'ISAB03 in some examples. Further, an audio I/O 824 may be coupled to second interface 820. Note that other architectures than the point-to-point architecture described above are possible. For example, instead of the point-to-point architecture, a system such as multiprocessor system 800 may implement a multi-drop interface or other such architecture.

### Example Core Architectures, Processors, and Computer Architectures.

Processor cores (“cores”) may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality.

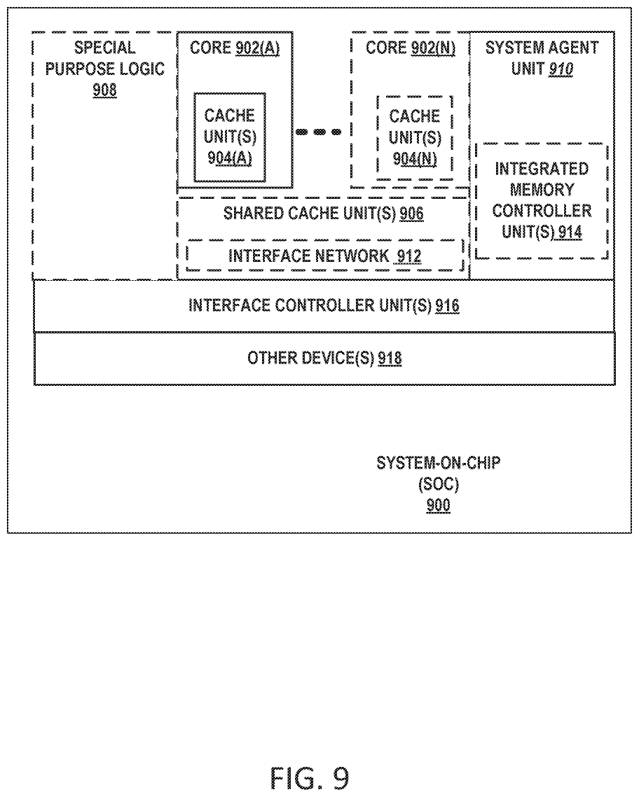

FIG. 9 illustrates a block diagram of an example SoC 900 that may have one or more processor cores and an integrated memory controller. The SoC 900 includes different components (hardware elements), also called “blocks” or subsystems.

The solid lined boxes illustrate an SoC 900 with a single processor core 902(A), system agent unit circuitry 910, and a set of one or more interface controller unit(s) circuitry 916, while the optional addition of the dashed lined boxes illustrates an alternative SoC 900 with multiple cores 902(A)-(N), a set of one or more integrated memory controller unit(s) circuitry 914 in the system agent unit circuitry 910, and special purpose logic 908, as well as a set of one or more interface controller units circuitry 916. Note that the SoC 900 may be one of the processors 870 or 880, or co-processor 838 or 815 of FIG. 8.

Thus, different implementations of the SoC 900 may include: 1) a CPU with the special purpose logic 908 being integrated graphics and/or scientific (throughput) logic (which may include one or more cores, not shown), and the cores 902(A)-(N) being one or more general purpose cores (e.g., general purpose in-order cores, general purpose out-of-order cores, or a combination of the two); 2) a coprocessor with the cores 902(A)-(N) being a large number of special purpose cores intended primarily for graphics and/or scientific (throughput); and 3) a coprocessor with the cores 902(A)-(N) being a large number of general purpose in-order cores. Thus, the SoC 900 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The SoC 900 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 904(A)-(N) within the cores 902(A)-(N), a set of one or more shared cache unit(s) circuitry 906, and external memory (not shown) coupled to the set of integrated memory controller unit(s) circuitry 914. The set of one or more shared cache unit(s) circuitry 906 may include one or more mid-level caches, such as level 2 (L2), level 3 (L3), level 4 (L4), or other levels of cache, such as a last level cache (LLC), and/or combinations thereof. While in some examples interface network circuitry 912 (e.g., a ring interconnect) interfaces the special purpose logic 908 (e.g., integrated graphics logic), the set of shared cache unit(s) circuitry 906, and the system agent unit circuitry 910, alternative examples use any number of well-known techniques for interfacing such units. In some examples, coherency is maintained between one or more of the shared cache unit(s) circuitry 906 and cores 902(A)-(N). In some examples, interface controller units circuitry 916 couple the cores 902 to one or more other devices 918 such as one or more I/O devices, storage, one or more communication devices (e.g., wireless networking, wired networking, etc.), etc.

In some examples, one or more of the cores 902(A)-(N) are capable of multi-threading. The system agent unit circuitry 910 includes those components coordinating and operating cores 902(A)-(N). The system agent unit circuitry 910 may include, for example, power control unit (PCU) circuitry and/or display unit circuitry (not shown). The PCU may be or may include logic and components needed for regulating the power state of the cores 902(A)-(N) and/or the special purpose logic 908 (e.g., integrated graphics logic). The display unit circuitry is for driving one or more externally connected displays.

The cores 902(A)-(N) may be homogenous in terms of instruction set architecture (ISA). Alternatively, the cores 902(A)-(N) may be heterogeneous in terms of ISA; that is, a subset of the cores 902(A)-(N) may be capable of executing an ISA, while other cores may be capable of executing only a subset of that ISA or another ISA.

### Example Core Architectures—In-Order and Out-of-Order Core Block Diagram.

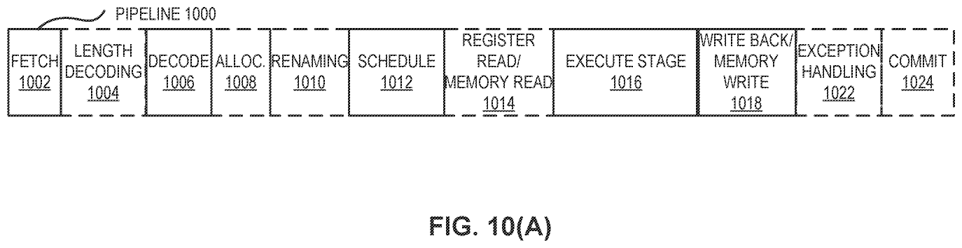

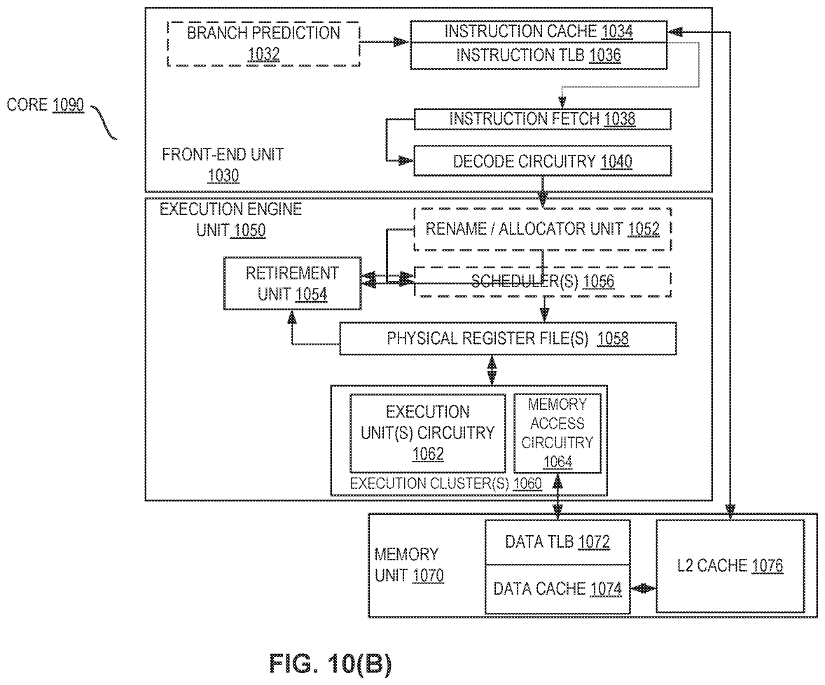

FIG. 10(A) is a block diagram illustrating both an example in-order pipeline and an example register renaming, out-of-order issue/execution pipeline according to examples. FIG. 10(B) is a block diagram illustrating both an example in-order architecture core and an example register renaming, out-of-order issue/execution architecture core to be included in a processor according to examples. The solid lined boxes in FIGS. 10(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 10(A), a processor pipeline 1000 includes a fetch stage 1002, an optional length decoding stage 1004, a decode stage 1006, an optional allocation (Alloc) stage 1008, an optional renaming stage 1010, a schedule (also known as a dispatch or issue) stage 1012, an optional register read/memory read stage 1014, an execute stage 1016, a write back/memory write stage 1018, an optional exception handling stage 1022, and an optional commit stage 1024. One or more operations can be performed in each of these processor pipeline stages. For example, during the fetch stage 1002, one or more instructions are fetched from instruction memory, and during the decode stage 1006, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1006 and the register read/memory read stage 1014 may be combined into one pipeline stage. In one example, during the execute stage 1016, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 10(B) may implement the pipeline 1000 as follows: 1) the instruction fetch circuitry 1038 performs the fetch and length decoding stages 1002 and 1004; 2) the decode circuitry 1040 performs the decode stage 1006; 3) the rename/allocator unit circuitry 1052 performs the allocation stage 1008 and renaming stage 1010; 4) the scheduler(s) circuitry 1056 performs the schedule stage 1012; 5) the physical register file(s) circuitry 1058 and the memory unit circuitry 1070 perform the register read/memory read stage 1014; the execution cluster(s) 1060 perform the execute stage 1016; 6) the memory unit circuitry 1070 and the physical register file(s) circuitry 1058 perform the write back/memory write stage 1018; 7) various circuitry may be involved in the exception handling stage 1022; and 8) the retirement unit circuitry 1054 and the physical register file(s) circuitry 1058 perform the commit stage 1024.

FIG. 10(B) shows a processor core 1090 including front-end unit circuitry 1030 coupled to execution engine unit circuitry 1050, and both are coupled to memory unit circuitry 1070. The core 1090 may be a reduced instruction set architecture computing (RISC) core, a complex instruction set architecture computing (CISC) core, a very long instruction word (VLIW) core, or a hybrid or alternative core type. As yet another option, the core 1090 may be a special-purpose core, such as, for example, a network or communication core, compression engine, coprocessor core, general purpose computing graphics processing unit (GPGPU) core, graphics core, or the like.

The front-end unit circuitry 1030 may include branch prediction circuitry 1032 coupled to instruction cache circuitry 1034, which is coupled to an instruction translation lookaside buffer (TLB) 1036, which is coupled to instruction fetch circuitry 1038, which is coupled to decode circuitry 1040. In one example, the instruction cache circuitry 1034 is included in the memory unit circuitry 1070 rather than the front-end circuitry 1030. The decode circuitry 1040 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1040 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1040 may be implemented using various different mechanisms. Examples of suitable mechanisms include, but are not limited to, look-up tables, hardware implementations, programmable logic arrays (PLAs), microcode read only memories (ROMs), etc. In one example, the core 1090 includes a microcode ROM (not shown) or other medium that stores microcode for certain macroinstructions (e.g., in decode circuitry 1040 or otherwise within the front-end circuitry 1030). In one example, the decode circuitry 1040 includes a micro-operation (micro-op) or operation cache (not shown) to hold/cache decoded operations, micro-tags, or micro-operations generated during the decode or other stages of the processor pipeline 1000. The decode circuitry 1040 may be coupled to rename/allocator unit circuitry 1052 in the execution engine circuitry 1050.

The execution engine circuitry 1050 includes the rename/allocator unit circuitry 1052 coupled to retirement unit circuitry 1054 and a set of one or more scheduler(s) circuitry 1056. The scheduler(s) circuitry 1056 represents any number of different schedulers, including reservations stations, central instruction window, etc. In some examples, the scheduler(s) circuitry 1056 can include arithmetic logic unit (ALU) scheduler/scheduling circuitry, ALU queues, address generation unit (AGU) scheduler/scheduling circuitry, AGU queues, etc. The scheduler(s) circuitry 1056 is coupled to the physical register file(s) circuitry 1058. Each of the physical register file(s) circuitry 1058 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1058 includes vector registers unit circuitry, writemask registers unit circuitry, and scalar register unit circuitry. These register units may provide architectural vector registers, vector mask registers, general-purpose registers, etc. The physical register file(s) circuitry 1058 is coupled to the retirement unit circuitry 1054 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1054 and the physical register file(s) circuitry 1058 are coupled to the execution cluster(s) 1060. The execution cluster(s) 1060 includes a set of one or more execution unit(s) circuitry 1062 and a set of one or more memory access circuitry 1064. The execution unit(s) circuitry 1062 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1056, physical register file(s) circuitry 1058, and execution cluster(s) 1060 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1064). It should also be understood that where separate pipelines are used, one or more of these pipelines may be out-of-order issue/execution and the rest in-order.

In some examples, the execution engine unit circuitry 1050 may perform load store unit (LSU) address/data pipelining to an Advanced Microcontroller Bus (AMB) interface (not shown), and address phase and writeback, data phase load, store, and branches.

The set of memory access circuitry 1064 is coupled to the memory unit circuitry 1070, which includes data TLB circuitry 1072 coupled to data cache circuitry 1074 coupled to level 2 (L2) cache circuitry 1076. In one example, the memory access circuitry 1064 may include load unit circuitry, store address unit circuitry, and store data unit circuitry, each of which is coupled to the data TLB circuitry 1072 in the memory unit circuitry 1070. The instruction cache circuitry 1034 is further coupled to the level 2 (L2) cache circuitry 1076 in the memory unit circuitry 1070. In one example, the instruction cache 1034 and the data cache 1074 are combined into a single instruction and data cache (not shown) in L2 cache circuitry 1076, level 3 (L3) cache circuitry (not shown), and/or main memory. The L2 cache circuitry 1076 is coupled to one or more other levels of cache and eventually to a main memory.

The core 1090 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1090 includes logic to support a packed data instruction set architecture extension (e.g., AVX1, AVX2), thereby allowing the operations used by many multimedia applications to be performed using packed data.

### Example Execution Unit(s) Circuitry.

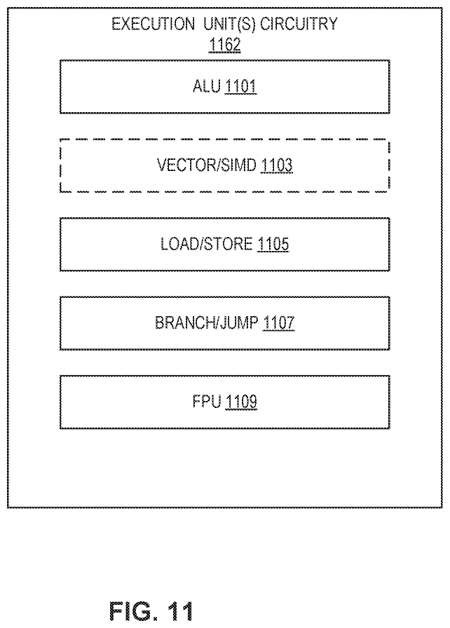

FIG. 11 illustrates examples of execution unit(s) circuitry 1162, such as execution unit(s) circuitry 1062 of FIG. 10(B). As illustrated, execution unit(s) circuitry 1062 may include one or more ALU circuits 1101, optional vector/single instruction multiple data (SIMD) circuits 1103, load/store circuits 1105, branch/jump circuits 1107, and/or Floating-point unit (FPU) circuits 1109. ALU circuits 1101 perform integer arithmetic and/or Boolean operations. Vector/SIMD circuits 1103 perform vector/SIMD operations on packed data (such as SIMD/vector registers). Load/store circuits 1105 execute load and store instructions to load data from memory into registers or store from registers to memory. Load/store circuits 1105 may also generate addresses. Branch/jump circuits 1107 cause a branch or jump to a memory address depending on the instruction. FPU circuits 1109 perform floating-point arithmetic. The width of the execution unit(s) circuitry 1062 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

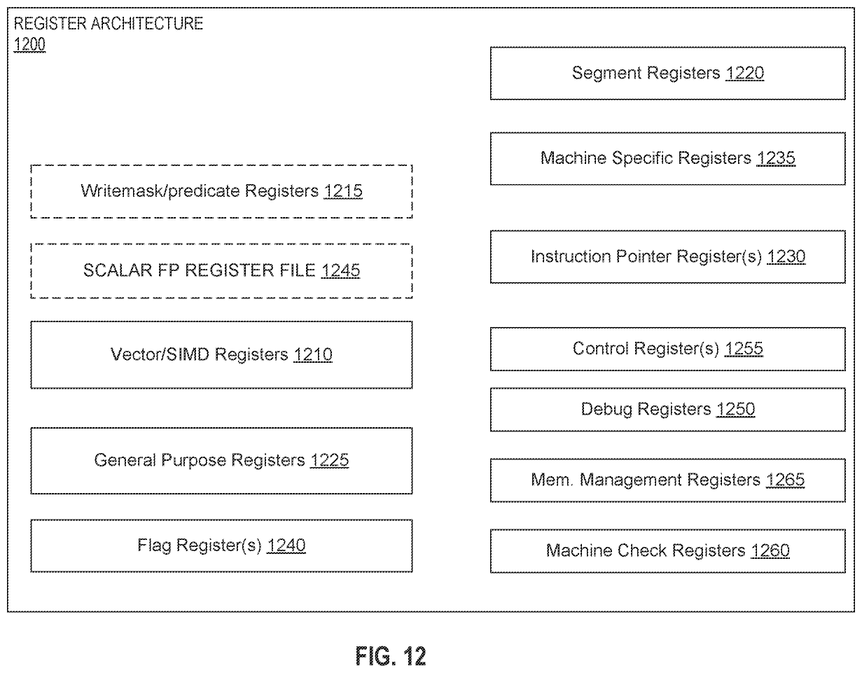

FIG. 12 is a block diagram of a register architecture 1200 according to some examples. As illustrated, the register architecture 1200 includes vector/SIMD registers 1210 that vary from 128-bit to 1,024 bits width. In some examples, the vector/SIMD registers 1210 are physically 512-bits and, depending upon the mapping, only some of the lower bits are used. For example, in some examples, the vector/SIMD registers 1210 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1200 includes writemask/predicate registers 1215. For example, in some examples, there are 8 writemask/predicate registers (sometimes called k0 through k7) that are each 16-bit, 32-bit, 64-bit, or 128-bit in size. Writemask/predicate registers 1215 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1215 corresponds to a data element position of the destination. In other examples, the writemask/predicate registers 1215 are scalable and consists of a set number of enable bits for a given vector element (e.g., 8 enable bits per 64-bit vector element).

The register architecture 1200 includes a plurality of general-purpose registers 1225. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1200 includes scalar floating-point (FP) register file 1245 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1240 (e.g., EFLAGS, RFLAGS, etc.) store status and control information for arithmetic, compare, and system operations. For example, the one or more flag registers 1240 may store condition code information such as carry, parity, auxiliary carry, zero, sign, and overflow. In some examples, the one or more flag registers 1240 are called program status and control registers.

Segment registers 1220 contain segment points for use in accessing memory. In some examples, these registers are referenced by the names CS, DS, SS, ES, FS, and GS.

Machine specific registers (MSRs) 1235 control and report on processor performance. Most MSRs 1235 handle system-related functions and are not accessible to an application program. Machine check registers 1260 consist of control, status, and error reporting MSRs that are used to detect and report on hardware errors.

One or more instruction pointer register(s) 1230 store an instruction pointer value. Control register(s) 1255 (e.g., CR0-CR4) determine the operating mode of a processor (e.g., processor 870, 880, 838, 815, and/or 1400) and the characteristics of a currently executing task. Debug registers 1250 control and allow for the monitoring of a processor or core's debugging operations.

Memory (mem) management registers 1265 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1200 may, for example, be used in register file/memory 'ISAB08, or physical register file(s) circuitry 15 58.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source 1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

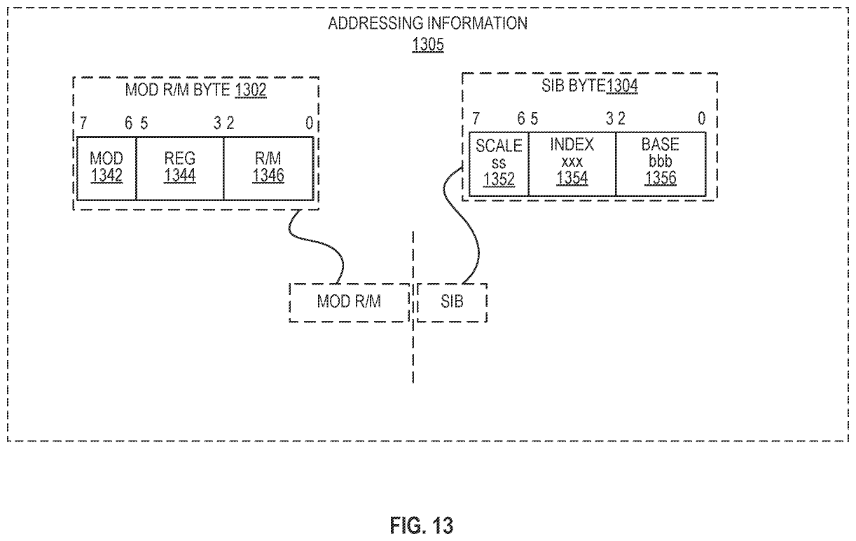

FIG. 13 illustrates examples of the addressing information field 1305. In this illustration, an optional MOD R/M byte 1302 and an optional Scale, Index, Base (SIB) byte 1304 are shown. The MOD R/M byte 1302 and the SIB byte 1304 are used to encode up to two operands of an instruction, each of which is a direct register or effective memory address. Note that both of these fields are optional in that not all instructions include one or more of these fields. The MOD R/M byte 1302 includes a MOD field 1342, a register (reg) field 1344, and R/M field 1346.

The content of the MOD field 1342 distinguishes between memory access and non-memory access modes. In some examples, when the MOD field 1342 has a binary value of 11 (11b), a register-direct addressing mode is utilized, and otherwise a register-indirect addressing mode is used.

The register field 1344 may encode either the destination register operand or a source register operand or may encode an opcode extension and not be used to encode any instruction operand. The content of register field 1344, directly or through address generation, specifies the locations of a source or destination operand (either in a register or in memory). In some examples, the register field 1344 is supplemented with an additional bit from a prefix (e.g., prefix 701) to allow for greater addressing.

The R/M field 1346 may be used to encode an instruction operand that references a memory address or may be used to encode either the destination register operand or a source register operand. Note the R/M field 1346 may be combined with the MOD field 1342 to dictate an addressing mode in some examples.

The SIB byte 1304 includes a scale field 1352, an index field 1354, and a base field 1356 to be used in the generation of an address. The scale field 1352 indicates a scaling factor. The index field 1354 specifies an index register to use. In some examples, the index field 1354 is supplemented with an additional bit from a prefix (e.g., prefix 701) to allow for greater addressing. The base field 1356 specifies a base register to use. In some examples, the base field 1356 is supplemented with an additional bit from a prefix (e.g., prefix 701) to allow for greater addressing. In practice, the content of the scale field 1352 allows for the scaling of the content of the index field 1354 for memory address generation (e.g., for address generation that uses 2scale*index+base).

Some addressing forms utilize a displacement value to generate a memory address. For example, a memory address may be generated according to 2scale*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 707 provides this value. Additionally, in some examples, a displacement factor usage is encoded in the MOD field of the addressing information field 705 that indicates a compressed displacement scheme for which a displacement value is calculated and stored in the displacement field 707.

In some examples, the immediate value field 709 specifies an immediate value for the instruction. An immediate value may be encoded as a 1-byte value, a 2-byte value, a 4-byte value, etc.

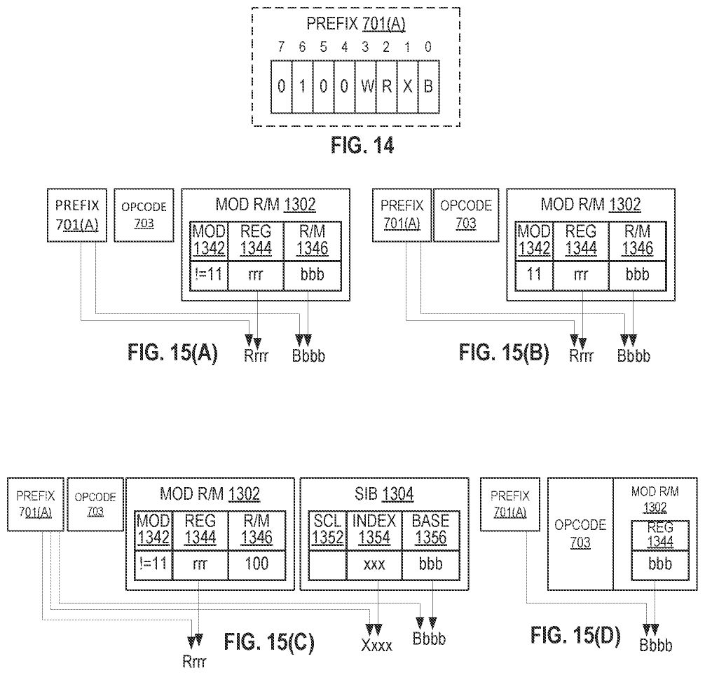

FIG. 14 illustrates examples of a first prefix 701(A). In some examples, the first prefix 701(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 701(A) may specify up to three registers using 3-bit fields depending on the format: 1) using the reg field 1344 and the R/M field 1346 of the MOD R/M byte 1302; 2) using the MOD R/M byte 1302 with the SIB byte 1304 including using the reg field 1344 and the base field 1356 and index field 1354; or 3) using the register field of an opcode.

In the first prefix 701(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (24) registers to be addressed, whereas the MOD R/M reg field 1344 and MOD R/M R/M field 1346 alone can each only address 8 registers.

In the first prefix 701(A), bit position 2 (R) may be an extension of the MOD R/M reg field 1344 and may be used to modify the MOD R/M reg field 1344 when that field encodes a general-purpose register, a 64-bit packed data register (e.g., a SSE register), or a control or debug register. R is ignored when MOD R/M byte 1302 specifies other registers or defines an extended opcode.

Bit position 1 (X) may modify the SIB byte index field 1354.

Bit position 0 (B) may modify the base in the MOD R/M R/M field 1346 or the SIB byte base field 1356; or it may modify the opcode register field used for accessing general purpose registers (e.g., general purpose registers 1225).

FIGS. 15(A)-(D) illustrate examples of how the R, X, and B fields of the first prefix 701(A) are used. FIG. 15(A) illustrates R and B from the first prefix 701(A) being used to extend the reg field 1344 and R/M field 1346 of the MOD R/M byte 1302 when the SIB byte 1304 is not used for memory addressing. FIG. 15(B) illustrates R and B from the first prefix 701(A) being used to extend the reg field 1344 and R/M field 1346 of the MOD R/M byte 1302 when the SIB byte 1304 is not used (register-register addressing). FIG. 15(C) illustrates R, X, and B from the first prefix 701(A) being used to extend the reg field 1344 of the MOD R/M byte 1302 and the index field 1354 and base field 1356 when the SIB byte 1304 being used for memory addressing. FIG. 15(D) illustrates B from the first prefix 701(A) being used to extend the reg field 1344 of the MOD R/M byte 1302 when a register is encoded in the opcode 703.

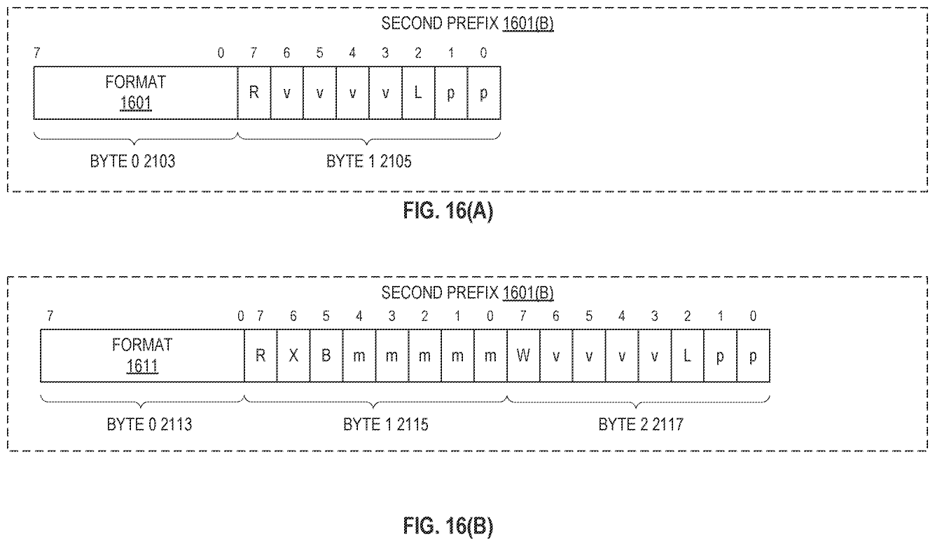

FIGS. 16(A)-(B) illustrate examples of a second prefix 701(B). In some examples, the second prefix 701(B) is an example of a VEX prefix. The second prefix 701(B) encoding allows instructions to have more than two operands, and allows SIMD vector registers (e.g., vector/SIMD registers 1210) to be longer than 64-bits (e.g., 128-bit and 256-bit). The use of the second prefix 701(B) provides for three-operand (or more) syntax. For example, previous two-operand instructions performed operations such as A=A+B, which overwrites a source operand. The use of the second prefix 701(B) enables operands to perform nondestructive operations such as A=B+C.

In some examples, the second prefix 701(B) comes in two forms—a two-byte form and a three-byte form. The two-byte second prefix 701(B) is used mainly for 128-bit, scalar, and some 256-bit instructions; while the three-byte second prefix 701(B) provides a compact replacement of the first prefix 701(A) and 3-byte opcode instructions.

FIG. 16(A) illustrates examples of a two-byte form of the second prefix 701(B). In one example, a format field 1601 (byte 0 1603) contains the value C₅H. In one example, byte 1 1605 includes an “R” value in bit [7]. This value is the complement of the “R” value of the first prefix 701(A). Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1346 to encode the instruction operand that references a memory address or encode either the destination register operand or a source register operand.

Instructions that use this prefix may use the MOD R/M reg field 1344 to encode either the destination register operand or a source register operand, or to be treated as an opcode extension and not used to encode any instruction operand.

For instruction syntax that support four operands, vvvv, the MOD R/M R/M field 1346 and the MOD R/M reg field 1344 encode three of the four operands. Bits [7:4] of the immediate value field 709 are then used to encode the third source register operand.

FIG. 16(B) illustrates examples of a three-byte form of the second prefix 701(B). In one example, a format field 1611 (byte 0 1613) contains the value C₄H. Byte 1 1615 includes in bits [7:5] “R,” “X,” and “B” which are the complements of the same values of the first prefix 701(A). Bits [4:0] of byte 1 1615 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit [7] of byte 2 1617 is used similar to W of the first prefix 701(A) including helping to determine promotable operand sizes. Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1346 to encode the instruction operand that references a memory address or encode either the destination register operand or a source register operand.

Instructions that use this prefix may use the MOD R/M reg field 1344 to encode either the destination register operand or a source register operand, or to be treated as an opcode extension and not used to encode any instruction operand.

For instruction syntax that support four operands, vvvv, the MOD R/M R/M field 1346, and the MOD R/M reg field 1344 encode three of the four operands. Bits [7:4] of the immediate value field 709 are then used to encode the third source register operand.

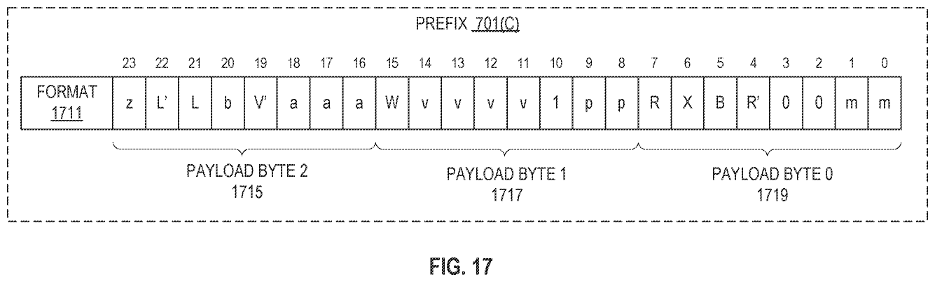

FIG. 17 illustrates examples of a third prefix 701(C). In some examples, the third prefix 701(C) is an example of an EVEX prefix. The third prefix 701(C) is a four-byte prefix.

The third prefix 701(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 12) or predication utilize this prefix.

Opmask register allow for conditional processing or selection control. Opmask instructions, whose source/destination operands are opmask registers and treat the content of an opmask register as a single value, are encoded using the second prefix 701(B).

The third prefix 701(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 701(C) is a format field 1711 that has a value, in one example, of 62H. Subsequent bytes are referred to as payload bytes 1715-1719 and collectively form a 24-bit value of P[23:0] providing specific capability in the form of one or more fields (detailed herein).

In some examples, P[1:0] of payload byte 1719 are identical to the low two mm bits. P[3:2] are reserved in some examples. Bit P[4] (R′) allows access to the high 16 vector register set when combined with P[7] and the MOD R/M reg field 1344. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1344 and MOD R/M R/M field 1346. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 701(A) and second prefix 1711(B) and may serve as an opcode extension bit or operand size promotion.

P[18:16] specify the index of a register in the opmask (writemask) registers (e.g., writemask/predicate registers 1215). In one example, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 701(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination or Source |
| | | | reg | | |
| VVVV | V′ | vvvv | | GPR, Vector | 2nd Source or Destination |
| RM | X | B | MOD R/M | GPR, Vector | 1st Source or Destination |
| | | | R/M | | |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

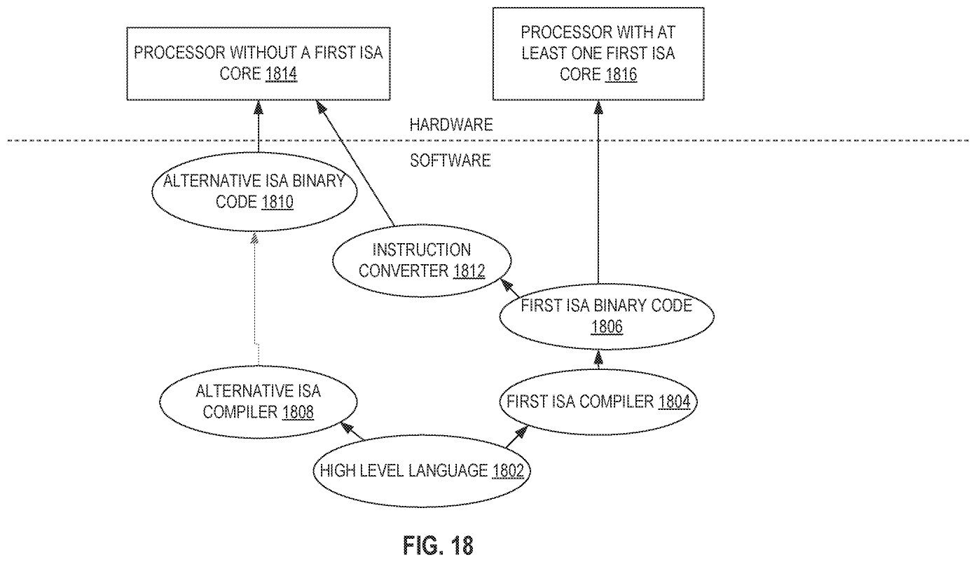

FIG. 18 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 18 shows a program in a high-level language 1802 may be compiled using a first ISA compiler 1804 to generate first ISA binary code 1806 that may be natively executed by a processor with at least one first ISA core 1816. The processor with at least one first ISA core 1816 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 1804 represents a compiler that is operable to generate first ISA binary code 1806 (e.g., object code) that can, with or without additional linkage processing, be executed on the processor with at least one first ISA core 1816. Similarly, FIG. 18 shows the program in the high-level language 1802 may be compiled using an alternative ISA compiler 1808 to generate alternative ISA binary code 1810 that may be natively executed by a processor without a first ISA core 1814. The instruction converter 1812 is used to convert the first ISA binary code 1806 into code that may be natively executed by the processor without a first ISA core 1814. This converted code is not necessarily to be the same as the alternative ISA binary code 1810; however, the converted code will accomplish the general operation and be made up of instructions from the alternative ISA. Thus, the instruction converter 1812 represents software, firmware, hardware, or a combination thereof that, through emulation, simulation or any other process, allows a processor or other electronic device that does not have a first ISA processor or core to execute the first ISA binary code 1806.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL). which defines structures, circuits, apparatuses, processors and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

### EXAMPLES

Illustrative examples of the technologies disclosed herein are provided below. An embodiment of the technologies may include any one or more, and any combination of, the examples described below.

Example 1 is an apparatus comprising a fully homomorphic encryption accelerator and a memory. The fully homomorphic encryption accelerator comprising a plurality of compute elements to support operations on polynomials; and a plurality of scratch pad memory units. Each scratch pad memory unit comprising a key generator module and a scratch pad memory. The key generator module to generate fully homomorphic encryption relinearization public keys from a seed, the fully homomorphic encryption relinearization public keys used by the plurality of compute elements to perform operations on polynomials. The scratch pad memory to store coefficients used by the plurality of compute elements to perform operations on polynomials. The memory to store data to be processed by the fully homomorphic encryption accelerator.

Example 2 includes the apparatus of Example 1, the key generator module optionally including a plurality of key generator circuitry, each key generator circuitry loaded with the seed in response to a Key Generation seed instruction.

Example 3 includes the apparatus of Example 2, optionally key generation operations are initiated in each key generator circuitry in response to a Key Generation start stop instruction.

Example 4 includes the apparatus of Example 2, optionally the key generator module comprises 16 key generator circuitry.

Example 5 includes the apparatus of Example 2, optionally the seed is 208 bits.

Example 6 includes the apparatus of Example 2, optionally each key generator circuitry includes a random number generators, samplers and buffers. The random number generator to generate raw random number generator values. The samplers to map the raw random number generator values received from the random number generator from a number space to a ciphertext modulus space. buffers to store valid values received from the samplers.

Example 7 includes the apparatus of Example 6, optionally the number space is 0-232 and the ciphertext modulus space is 0-q.

Example 8 includes the apparatus of Example 7, optionally the fully homomorphic encryption accelerator further comprises a compute engine control block. The compute engine control block including a Keygen valid vector. The Keygen valid vector including one bit for each key generator circuitry, a respective bit in the Keygen valid vector set to valid when the buffers in the key generator circuitry are full.

Example 9 includes the apparatus of Example 8, optionally in response to a Key Generation load instruction after all bits in the keygen valid vector are valid, valid values stored in the buffers are output to a compute engine and all bits in the keygen valid vector are cleared.

Example 10 includes the apparatus of Example 9, optionally the buffers comprise FIFOs, the FIFOs to store 128 bytes of valid values.

Example 11 is system comprising a processor core, a fully homomorphic encryption accelerator and a memory. The fully homomorphic encryption accelerator comprising a plurality of compute elements to support operations on polynomials; and a plurality of scratch pad memory units. Each scratch pad memory unit comprising a key generator module and a scratch pad memory. The key generator module to generate fully homomorphic encryption relinearization public keys from a seed, the fully homomorphic encryption relinearization public keys used by the plurality of compute elements to perform operations on polynomials. The scratch pad memory to store coefficients used by the plurality of compute elements to perform operations on polynomials. The memory to store data to be processed by the fully homomorphic encryption accelerator.

Example 12 includes the system of Example 11, the key generator module optionally including a plurality of key generator circuitry, each key generator circuitry loaded with the seed in response to a Key Generation seed instruction.

Example 13 includes the system of Example 12, optionally key generation operations are initiated in each key generator circuitry in response to a Key Generation start stop instruction.

Example 14 includes the system of Example 12, optionally each key generator circuitry includes a random number generators, samplers and buffers. The random number generator to generate raw random number generator values. The samplers to map the raw random number generator values received from the random number generator from a number space to a ciphertext modulus space. buffers to store valid values received from the samplers.

Example 15 includes the system of Example 14, optionally the fully homomorphic encryption accelerator further comprises a compute engine control block. The compute engine control block including a Keygen valid vector. The Keygen valid vector including one bit for each key generator circuitry, a respective bit in the Keygen valid vector set to valid when the buffers in the key generator circuitry are full.

Example 16 includes the system of Example 15, optionally in response to a Key Generation load instruction after all bits in the keygen valid vector are valid, valid values stored in the buffers are output to a compute engine and all bits in the keygen valid vector are cleared.

Example 17 includes the system of Example 16, optionally the buffers comprise FIFOs, the FIFOs to store 128 bytes of valid values.

Example 18 is a method including generating, by a key generator module in a fully homomorphic encryption accelerator, fully homomorphic encryption relinearization public keys from a seed, the fully homomorphic encryption relinearization public keys. The method also includes using, by a plurality of compute elements, in the fully homomorphic encryption accelerator, the fully homomorphic encryption relinearization public keys to perform operations on polynomials. The method also includes storing, in a scratch pad memory in the fully homomorphic encryption accelerator, coefficients used by the plurality of compute elements to perform operations on polynomials. The method also includes storing, in a memory, data to be processed by the fully homomorphic encryption accelerator.

Example 19 includes the system of Example 18, optionally including loading a plurality of key generator circuitry in the key generator module with the seed in response to a Key Generation seed instruction.

Example 20 includes the system of Example 19, optionally including initiating key generation operations in each key generator circuitry in response to a Key Generation start stop instruction.

Example 21 is at least one machine readable medium that includes a plurality of instructions that in response to being executed by a system can cause the system to carry out a method according to any one of examples 18 to 20.

Example 22 is an apparatus that includes means for performing the methods of any one of examples 18 to 20.

What is claimed is:

1. An apparatus comprising:
a fully homomorphic encryption accelerator comprising:
a plurality of compute elements to support operations on polynomials; and
a plurality of scratch pad memory units, each scratch pad memory unit comprising:
a key generator module to generate fully homomorphic encryption relinearization public keys from a seed, the fully homomorphic encryption relinearization public keys used by the plurality of compute elements to perform operations on polynomials; and
scratch pad memory to store coefficients used by the plurality of compute elements to perform operations on polynomials; and
memory to store data to be processed by the fully homomorphic encryption accelerator.

2. The apparatus of claim 1, wherein the key generator module comprises:
a plurality of key generator circuitry, each key generator circuitry loaded with the seed in response to a Key Generation seed instruction.

3. The apparatus of claim 2, wherein key generation operations are initiated in each key generator circuitry in response to a Key Generation start stop instruction.

4. The apparatus of claim 2, wherein the key generator module comprises 16 key generator circuitry.

5. The apparatus of claim 2, wherein the seed is 208 bits.

6. The apparatus of claim 2, wherein each key generator circuitry comprises:
a random number generator to generate raw random number generator values,
samplers to map the raw random number generator values received from the random number generator from a number space to a ciphertext modulus space; and
buffers to store valid values received from the samplers.

7. The apparatus of claim 6, wherein the number space is 0-232 and the ciphertext modulus space is 0-q.

8. The apparatus of claim 7, wherein the fully homomorphic encryption accelerator further comprises:
a compute engine control block, the compute engine control block including a Keygen valid vector, the Keygen valid vector including one bit for each key generator circuitry, a respective bit in the Keygen valid vector set to valid when the buffers in the key generator circuitry are full.

9. The apparatus of claim 8, in response to a Key Generation load instruction after all bits in the keygen valid vector are valid, valid values stored in the buffers are output to a compute engine and all bits in the keygen valid vector are cleared.

10. The apparatus of claim 9, wherein the buffers comprise FIFOs, the FIFOs to store 128 bytes of valid values.

11. A system comprising:
a processor core;
a fully homomorphic encryption accelerator comprising:
a plurality of compute elements to support operations on polynomials; and
a plurality of scratch pad memory units, each scratch pad memory unit comprising:
a key generator module to generate fully homomorphic encryption relinearization public keys from a seed, the fully homomorphic encryption relinearization public keys used by the plurality of compute elements to perform operations on polynomials; and
scratch pad memory to store coefficients used by the plurality of compute elements to perform operations on polynomials; and
memory to store data to be processed by the fully homomorphic encryption accelerator.

12. The system of claim 11, wherein the key generator module comprises:
a plurality of key generator circuitry, each key generator circuitry loaded with the seed in response to a Key Generation seed instruction.

13. The system of claim 12, wherein key generation operations are initiated in each key generator circuitry in response to a Key Generation start stop instruction.

14. The system of claim 12, wherein each key generator circuitry comprises:
a random number generator to generate raw random number generator values,
samplers to map the raw random number generator values received from the random number generator from a number space to a ciphertext modulus space; and
buffers to store valid values received from the samplers.

15. The system of claim 14, wherein the fully homomorphic encryption accelerator further comprises:
a compute engine control block, the compute engine control block including a Keygen valid vector, the Keygen valid vector including one bit for each key generator circuitry, a respective bit in the Keygen valid vector set to valid when the buffers in the key generator circuitry are full.

16. The system of claim 15, in response to a Key Generation load instruction after all bits in the keygen valid vector are valid, valid values stored in the buffers are output to a compute engine and all bits in the keygen valid vector are cleared.

17. The system of claim 16, wherein the buffers comprise FIFOs, the FIFOs to store 128 bytes of valid values.

18. A method comprising:
generating, by a key generator module in a fully homomorphic encryption accelerator, fully homomorphic encryption relinearization public keys from a seed, the fully homomorphic encryption relinearization public keys;
using, by a plurality of compute elements, in the fully homomorphic encryption accelerator, the fully homomorphic encryption relinearization public keys to perform operations on polynomials;
storing, in a scratch pad memory in the fully homomorphic encryption accelerator, coefficients used by the plurality of compute elements to perform operations on polynomials; and
storing, in a memory, data to be processed by the fully homomorphic encryption accelerator.

19. The method of claim 18, further comprises:
loading a plurality of key generator circuitry in the key generator module with the seed in response to a Key Generation seed instruction.

20. The method of claim 19, further comprises:
initiating key generation operations in each key generator circuitry in response to a Key Generation start stop instruction.
